(19) United States
(12) Patent Application Publication
(10) Pub. No.: US 2009/0004355 A1
(43) Pub. Date: Jan. 1, 2009

(54) ERYTHRITOL-CONTAINING TABLETOP SWEETENERS AND METHODS OF PRODUCING SAME

(76) Inventor: Steven J. Catani, Athens, GA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/147,075

(22) Filed: Jun. 26, 2008

Related U.S. Application Data
(60) Provisional application No. 60/947,054, filed on Jun. 29, 2007.

(51) Int. Cl. A23L 1/236

(52) U.S. Cl. 426/548

(57) ABSTRACT

A sweetener composition having erythritol and a stevia extract, wherein from about 20% to about 75% of the sweetness of the composition comes from stevia and the stevia has a Rebaudioside A level of from about 80 wt % to about 99 wt % relative to all steviol glycosides that is useful as a tabletop sweetener. The sweetener composition can be formulated as cubes, granules for use in sachets or packets, and tablets.

### CROSS-REFERENCE TO RELATED APPLICATIONS

This application claims the benefit of priority from U.S. Provisional Patent Application No. 60/947,054, filed on Jun. 29, 2007, the content of which is incorporated by reference.

### FIELD OF THE INVENTION

The present invention is directed to erythritol-based sweetener compositions and methods of making such compositions. The erythritol-based sweetener compositions of the present invention include stevia extract.

### BACKGROUND OF THE INVENTION

People often customize the taste of food and beverages by adding sweeteners thereto. For example, tabletop sweeteners are added to beverages, such as, coffee and tea; on cereals; on fruit; and as toppings on baked goods. Sweetening a food or beverage with a tabletop sweetener alters its flavor and usually increases its appeal. This behavior is found in all cultures, but is especially prevalent in western cultures.

Personal taste creates considerable variability in the amount of sweetness that one person prefers in a given food or beverage versus another person. For example, the amount of sweetness incorporated into a foodstuff during commercial production may not be adequate to satisfy some consumers while other consumers may find that the same amount of sweetness to be excessive. Moreover, consumers often desire to reduce their caloric intake for health or lifestyle reasons. Therefore, there exists a long-felt need for tabletop sweetener products that consumers may use to increase the sweetness of a product at the time of consumption that are consistent with their personal preferences and minimize additional caloric burden.

Tabletop sweeteners are the primary vehicle by which such taste customization is accomplished. Tabletop sweeteners are presently available in many different forms, including, granular, tablets, cohesive non-free flowing compositions (e.g., cubes), and the like.

Many types of sweeteners are available as tabletop sweeteners. These include natural sweeteners, such as sucrose (i.e., cane sugar), honey, high fructose corn syrup, molasses, maple syrup, brown rice syrup, fruit juice sweeteners, barley malt, and the like and artificial sweeteners, such as, sucralose, aspartame, saccharine, and the like.

Commonly available sweeteners have slightly different tastes that are variably preferred by individuals. Many sweeteners impart a bitter taste to the foods they sweeten. Saccharin, for example, is a sweetener that is known to impart a bitter taste. Other sweeteners have other taste components such as lingering metallic tastes, cooling or drying sensations, or combinations of the above sensations. Food ingredients have been used to overcome the bitterness. For example, cream of tartar is included in commonly sold saccharin packets. Additionally, several organizations, such as the Linguagen have recently disclosed compounds that block bitter taste by modifying taste receptor signaling.

The most common sweeteners are nutritive sweeteners. Nutritive sweeteners not only provide sweetness, but are also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in wide spread use, is produced from many sources, e.g., sugar cane and sugar beet roots.

Sugar alcohols are another form of sweetener. Sugar alcohols vary in sweetness from about half as sweet to about as sweet as sucrose. Accordingly, sugar alcohols may be used in place of sugar. Sugar alcohols have about one-half to three-quarters the amount of calories of sugar on a per weight basis. Sugar alcohols are slowly and incompletely absorbed from the small intestine into the blood. Absorbed sugar alcohols are converted to energy by processes that require little or no insulin. Accordingly, these sweeteners may be used by diabetics or those on low-carbohydrate diets.

High intensity sweeteners are well known alternatives to nutritive sweeteners. High intensity sweeteners provide sweetness without the calories and other metabolic impacts of the nutritive sweeteners. In many cases, high intensity sweeteners provide a sweet flavor that is preferred to nutritive sweeteners. Some high intensity sweeteners, such as, aspartame, are nutritive, but are so intense that they still provide negligible calories because very small amounts are required. Other high intensity sweeteners, such as, for example sucralose, are not absorbed when ingested and are, therefore, non-nutritive sweeteners.

Often the makers or users of these sweeteners add other components to them to overcome a less pleasant taste, for example, a bitter taste. For example, cream of tartar may be added to saccharin to offset its bitterness; and 2,4-dihydroxybenzoic acid may be added to sucralose to control lingering sweetness.

Erythritol has a strong cooling effect (i.e., negative heat of solution), which is often described as “brightness,” when it dissolves in water. While this effect may be appropriate in some confectionary applications, it is not considered ideal for tabletop sweeteners.

Several strategies have been used to overcome this problem for erythritol-containing tabletop sweeteners. For example fructo-oligosaccharides (“FOS”), which have a positive heat of solution, can be blended with erythritol to balance the heat of solution. Very commonly, inulin is combined with erythritol, due to inulin offering a complementary positive heat of solution to balance the heat of solution and non-crystallizing properties. Unfortunately, inulin has a propensity to cause gas and bloating when consumed in moderate to large quantities, particularly in individuals unaccustomed to it. Other sugar alcohols are sometimes utilized with erythritol, particularly isomalt, due to their minimally negative heat of solution. Glycerin, which has a positive heat of solution, moderate hygroscopicity, and non-crystallizing liquid form has also been used.

Other sweet or bland bulking agents with positive heats of solution can also be used. These, however, all add bulk, calories, and potentially gastro-intestinal side effects, all of which are undesirable attributes in a tabletop sweetener composition.

What is needed is a tabletop sweetener composition that minimizes the erythritol's brightness without the calories and potential gastro-intestinal side effects associated with previously known methods.

Several products are available that employ erythritol as a carrier for the high intensity sweetener stevia. Typical formulas are designed such that 70-99% of the sweetness delivered comes from stevia, with 98.5 to 99% of the total formula on a weight basis being erythritol.

Surprisingly, it has been found that erythritol-containing tabletop sweetener compositions containing very small amounts of stevia extracts unexpectedly mask the “bright” taste normal associated with erythritol. This effect occurs at levels that are about 300 times less than those previously known. The level is also several times less than compositions where stevia is the primary sweetener.

### SUMMARY OF THE INVENTION

A sweetening composition comprising, consisting essentially of and/or consisting of erythritol and a stevia extract, wherein from about 20% to about 75% of the sweetness of the composition comes from the stevia and the stevia has a Rebaudioside A level of from about 80 wt % to about 99 wt % relative to all steviol glycosides.

A sweetening composition comprising, consisting essentially of and/or consisting of erythritol and stevia in a weight ratio of between about 200:about 1 to about 2000:about 1.

A sweetening composition comprising, consisting essentially of and/or consisting of erythritol and stevia, wherein the stevia has a Rebaudioside A level of from about 80 wt % to about 99 wt % relative to all steviol glycosides.

A sweetening composition comprising, consisting essentially of and/or consisting of erythritol and stevia, wherein stevia is present in an amount of from about 0.05 wt % to about 0.5 wt % of the composition and has a Rebaudioside A level of from about 80 wt % to about 99 wt % relative to all steviol glycosides.

### DETAILED DESCRIPTION

As used herein, the term “high intensity sweetener” means a substance that provides a high sweetness per unit mass compared to a nutritive sweetener and provides little or no nutritive value. Many high intensity sweeteners are known to those skilled in the art and any may be used in the present invention. Examples of high intensity sweeteners useful in the present invention include, for example, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, extracts of sweet plants, such as stevia, thaumatin, salts, and combinations thereof. A preferred high intensity sweetener according to the present invention is sucralose.

As used herein, the term “sugar alcohol” means a food-grade alcohol derived from a sugar molecule. Sugar alcohols useful in the present invention include, for example, isomalt, erythritol, hydrogenated isomaltulose, hydrogenated starch hydrolyzates, lactitol, maltitol, mannitol, sorbitol, xylitol, and combinations thereof.

As used herein, a “food-grade” material is one that conforms to the standards for foods deemed safe for human consumption set forth in the Codex Alimentarius produced by the World Health Organization (1999).

As used herein, a gram (or other given amount) of Sucrose Equivalent Sweetness (“SES”) means the amount of high intensity sweetener needed to be added to an 8 ounce glass of water in order to provide the same sweetness as an independent 8 ounce glass of water containing one gram (or the other given amount) of sucrose. For example, 1/200 g of aspartame will equal about one gram of SES because aspartame is about 200 times sweeter than sucrose. Similarly, about 1/500 g to about 1/600 g of sucralose will provide one gram of SES because sucralose is about 500 to about 600 times sweeter than sucrose.

As used herein, all numerical ranges provided are intended to expressly include at least all numbers that fall between the endpoints of ranges.

Preferably, the sweetening compositions of the present invention contain from about 1 gram to about 10 grams of SES. More preferably, the sweetening compositions of the present invention contain from about 1 grams to about 5 grams of SES.

### Erythritol

Erythritol (butane-1,2,3,4-tetraol) is a natural, low calorie sweetener that has long been part of the human diet. It has a bright, sweet taste that is about 70% the sweetness of sucrose (i.e., cane sugar) on a weight basis. Erythritol contains less than 0.2 kcals per gram providing the equivalent of a teaspoon of sugar for around 1.2 kcals. While this is not as low as high intensity sweeteners like sucralose, which have no calories, it compares very favorable with sucrose (16 kcals/tsp), fructose (14 kcal/tsp SES), and tagatose (6.6 kcals/tsp SES).

Erythritol is absorbed into the bloodstream in the small intestine, and then for the most part excreted unchanged in the urine. Because erythritol is normally absorbed before it enters the large intestine, it does not normally cause laxative effects as are often experienced after over-consumption of other sugar alcohols and most people will consume erythritol with no side effects. This is important, as most other sugar alcohols are not absorbed directly by the body in this manner.

One significant negative aspect of the use of erythritol is the cooling or brightening effect. This is undesireable by many sweetener users.

Erythritol has been used in other ways. For example it is known to mask bitter and metallic tastes from certain high intensity sweeteners. A well-known example is extracts of the native south American plant Stevia Rebaudiana Compositae Bertoni. The components of the aqueous extracts of this plant, known as steviosides and rebaudiosides are very sweet (180-300 times sweeter than sucrose) but have metallic and bitter notes. Previously disclosed formulas use small amounts of erythritol to mask the bitter notes in compositions where the primary sweetness is coming from stevia.

We have found that small amounts of stevia, levels that are far below those that balance the heat of solution like FOS or inulin can, can mask the brightness effect of erythritol. Most surprising is that the effective amount of stevia is within a specific range. In other words, at a both high and low level of sweetness from stevia extract the effect is not found, but within a certain range the stevia extracts reduces the brightness effect of erythritol. The high end of the effective stevia range of the present invention is believed to be below all previously disclosed compositions.

### Stevia

Stevioside, sometimes referred to as stevia, (13-[(2-O-β-D-glucopyranosyl)oxy]-kaur-16-en-18-oic acid-4α-β-D-glucopyranosyl ester) and Rebaudioside-A are exemplary glycosides of the diterpene derivative steviol, extracted and refined from Stevia rebaudiana bertoni (also known as eupatorium rebaudianum bertoni) leaves. These glycosides are high intensity sweeteners, about 100 to about 500 times that of sucrose, that can used in a wide range of low or reduced calorie food products and beverages.

Stevia rebaudiana is native in South America. Both the plant and extracts of the plant have been used for several years as a sweetener in South America, Asia, Japan and China.

Other sweet glycosides can also be extracted from the Stevia plant. These have varying degrees of sweetness. As used herein “Stevia Extract” means a sweet glycoside extracted from a Stevia plant. Table 1 contains typical glycoside compositions in the stevia plant leaves.

TABLE 1

| | Concentration in Leaves | | | % of Glycosides |
|---|---|---|---|---|
| Steviol Glycoside | low | high | average | average |
| Stevioside | 5% | 22% | 14% | 57% |
| Rebaudioside-A | 1.50% | 10% | 6% | 24% |
| Rebaudioside-B | 0% | 4% | 2% | 8% |
| Rebaudioside-C | 0% | 4% | 2% | 8% |
| Rebaudioside-D | 0% | 0.30% | 0% | 1% |
| Rebaudioside-E | 0% | 0.30% | 0% | 1% |
| | 7% | 41% | 24% | 100% |

### Distribution of Glycosides in Stevia rebuadiana Leaves

Methods to selectively extract one or another of the gylocsides have been previously disclosed.

Several grades of stevia are available, better grades having a higher Rebaudioside A level as they contribute lower bitter taste levels. For these compositions stevia extracts with Rebaudioside A level higher than 80 wt % relative to all steviol glycosides are preferred to those with 90 wt % being more preferred and those with >95% being even more preferred.

A most surprising aspect of the new compositions is the fact that there are minimum and maximum levels of stevia that reduce the brightness or cooling effect of the erythritol. A certain level of stevia is needed to get the reduction effect, but too high a level makes the effect go away. The stevia should be from about 20% to about 75% of the sweetness in the composition, more preferably from about 20% to about 50%, and even more preferably about 40% to about 50% of the sweetness delivered by the composition. Known products contain stevia levels above the range where the brightness or cooling reduction effect is seen.

Alternatively, the composition should have from about 0.05 to about 0.50 wt % stevia, more preferably from about 0.05 to about 0.25 wt % stevia, and even more preferably from about 0.1 to about 0.20 wt % stevia, based on the total weight of the composition.

The preferred amount of stevia to get the brightness or cooling reduction effect can also be stated in the ratio of erythritol to stevia. On a weight basis, the preferred ratio is from about 200:about 1 to about 2000:about 1, an even more preferred ratio is from about 400:about 1 to about 2000:about 1, and a most preferred ratio is from about 400:about 1 to about 700:about 1.

The compositions can be provided in a number of unit dose delivery forms for example, sachets or packets are common unit delivery forms. Cubes are another common unit dose alternative. These unit forms typically contain from about 2 to about 10 grams of SES. A composition of the present invention can deliver 0.02 to 0.001 grams of stevia per unit package, more preferably 0.005 to 0.0015 grams of stevia per unit package, and even more preferably 0.003 to 0.0020 grams of stevia per unit package.

TABLE 2

| | HIS | | | | Stevita Brand | Stevita Brand | Japanese Market |
|---|---|---|---|---|---|---|---|
| | Market | | Stevia | NSI | supreme | spoonable | Stevia |
| | reference | | Plus | Stevia | packets | packets | blend |
| | MaltoDextrin | Sugar | FOS | Stevia | Stevia | Stevia | Erythirtol |
| | Sucralose | Sucrose | Stevia 65 | FOS | Erythritol | Erythritol | Stevia 65 |
| Maltodextrin | 1 | | | 0.50 | | | 0.00 |
| FOS | | | 1.00 | 0.48 | | | 0.00 |
| Erythritol | | | | | 1.00 | 1.00 | 98.70 |
| Fructose | | | | | | | 0.00 |
| Molasas Solids | | | | | | | 0.00 |
| Agave Nector (Hydrolysed) | | | | | | | 0.00 |
| Sucralose | 0.0134 | | | | | | |
| Sucrose | | 4.00 | | | | | 0.00 |
| Concentrated Stevia (99 reb) | | | | | | | |
| Concentrated Stevia (90 reb) | | | | | | | |
| Concentrated Stevia (80 reb) | | | | | | | |
| Concentrated Stevia (65 reb) | | | | | 0.0450 | 0.0128 | |
| Stevia Extract (~24% reb) | | | 0.0217 | 0.0250 | | | 1.30 |
| Batch | 1.0134 | 4.0000 | 1.0217 | 1.0050 | 1.0450 | 1.0128 | 100.0000 |
| g stevia/batch | 0.0000 | 0.0000 | 0.0217 | 0.0250 | 0.0450 | 0.0128 | 1.3000 |
| mg stevia/tsp SES | 0.0 | 0.0 | 21.6 | 21.9 | 14.5 | 12.7 | 17.1 |
| g SES/batch | 8.05 | 4.00 | 4.01 | 4.56 | 12.45 | 4.05 | 303.45 |
| tsp SES/batch | 2.01 | 1.00 | 1.00 | 1.14 | 3.11 | 1.01 | 75.86 |
| grams SES/Gram | 7.94 | 1.00 | 3.92 | 4.54 | 11.91 | 4.00 | 3.03 |
| grams/tsp SES | 0.504 | 4.000 | 1.020 | 0.882 | 0.336 | 1.000 | 1.318 |
| cal/batch | 4.00 | 16.00 | 1.50 | 2.72 | 0.00 | 0.00 | 0.00 |
| cal tsp SES | 1.99 | 16.00 | 1.50 | 2.39 | 0.00 | 0.00 | 0.00 |
| % of sweetness from Stevia | 0.0% | 0.0% | 97.5% | 98.8% | 94.4% | 82.7% | 77.2% |
| wt % stevia | 0.00% | 0.00% | 2.12% | 2.49% | 4.31% | 1.27% | 1.30% |
| wt % erythritol:wt % stevia | | | | | 22 | 78 | 76 |

### Typical Disclosed Compostions

The compositions can contain other components, including flavors, aroma component, other nutritional component, and mixtures thereof. For example the compositions can contain FOS to further reduce the brightness of the composition. The amount of FOS is an amount readily determined by those skilled in the art.

As used herein, unless otherwise indicated, the term “flavor” means any food-grade material that may be added to the present compositions to provide a desired flavor to a foodstuff. Flavors useful in the present invention include, for example, cream, hazelnut, vanilla, chocolate, cinnamon, pecan, lemon, lime, raspberry, peach, mango, vanillin, butter, butterscotch, tea, orange, tangerine, caramel, strawberry, banana, grape, plum, cherry, blueberry, pineapple, elderberry, watermelon, bubblegum, cantaloupe, guava, kiwi, papaya, coconut, mint, spearmint, derivatives, and combinations thereof.

As used herein, unless otherwise indicated, the term “aroma component” means any food-grade volatile substance that may be employed to produce a desired scent, for example, when mixed with a foodstuff. Aromas useful in the present invention include, for example, essential oils (citrus oil), expressed oils (orange oil), distilled oils (rose oil), extracts (fruits), anethole (liquorice, anise seed, ouzo, fennel), anisole (anise seed), benzaldehyde (marzipan, almond), benzyl alcohol (marzipan, almond), camphor (cinnamomum camphora), cinnamaldehyde (cinnamon), citral (citronella oil, lemon oil), d-limonene (orange) ethyl butanoate (pineapple), eugenol (clove oil), furaneol (strawberry), furfural (caramel), linalool (coriander, rose wood), menthol (peppermint), methyl butanoate (apple, pineapple), methyl salicylate (oil of wintergreen), neral (orange flowers), nerolin (orange flowers), pentyl butanoate (pear, apricot), pentyl pentanoate (apple, pineapple), sotolon (maple syrup, curry, fennugreek), strawberry ketone (strawberry), substituted pyrazines, e.g., 2-ethoxy-3-isopropylpyrazine; 2-methoxy-3-sec-butylpyrazine; and 2-methoxy-3-methylpyrazine (toasted seeds of fenugreek, cumin, and coriander), thujone (juniper, common sage, Nootka cypress, and wormwood), thymol (camphor-like), trimethylamine (fish), vanillin (vanilla), and combinations thereof. Preferred aroma components according to the present invention include, essential oils (citrus oil), expressed oils (orange oil), distilled oils (rose oil), extracts (fruits), benzaldehyde, d-limonene, furfural, menthol, methyl butanoate, pentyl butanoate, salts, derivatives, and combinations thereof.

The aroma component may be present in any amount in the composition. Preferably, the aroma component is present in an amount from about 2- to about 10-times the detectable amount. More preferably, the aroma component is present in an amount from about 2- to about 5-times the detectable amount. As used herein, unless otherwise indicated, the term “detectable amount” is the amount of the aroma component required to produce a scent detectable in the foodstuff. The gas-releasing system of the present invention enhances the sensory experience by releasing and dispersing the aroma component(s).

The compositions of the present invention can also include other high intensity sweeteners or sugar alcohols.

The composition can be packaged in sachets or packets, dissolvable sweetening strips, sprays, drops, as a bulk sweetener, in cubes, or any normal sugar forms. Unit dosage forms like sachets and cubes can contain from about 2 to about 10 grams of SES. Bulk products can be formulated to contain from about 2 to about 100 grams of SES per teaspoon of volume.

Sweetener cubes are cohesive non-free flowing compositions that include bulking agents. Bulking agents are typically crystalline carbohydrates, such as, sucrose, which are also available in combination with high intensity sweeteners. More recently a number of lower caloric burden bulking agents have entered the market. Some of these lower caloric burden bulking agents have physical and sensory characteristics similar to sucrose, and others have only a few physical or sensory characteristics similar to sucrose and/or some undesirable characteristics.

As used herein, unless otherwise indicated, the term “binder” refers to any food-grade material that is suitable for facilitating the pressing and formation of tablets. The selection of an appropriate binder is not critical and embraces any conventional binder so long as the binder does not substantially interfere with the self-mixing or the organoleptic properties of the foodstuff. Non-limiting examples of suitable binders useful in the present invention, include microcrystalline cellulose, gum tragacanth, gelatin, leucine, lactose, and combinations thereof. Preferably, the binder, if used, accounts for about 10% to about 15%, by weight of the total composition.

The following examples are provided to further illustrate the compositions and methods of the present invention. These examples are illustrative only and are not intended to limit the scope of the invention in any way.

### EXAMPLES

### Example 1

0.130 grams of stevia powder (Stevita Co., Inc., Arlington, Tex., 65% Rebaudioside-A) is dry blended by sequential transfer between two 12 ounce containers with 80 grams of erythritol (Eridex™, Cargill Inc., Minneapolis, Minn.). 2 drops of water are added to stabilize the mixture. After the water is added the composition is further mixed by additional sequential transfer until a free flowing pourable composition is obtained.

The composition is 99.84% erythritol. The ratio of sweetness contribution (Erythritol:Stevia) is 2.4:1 and the weight ratio is 615:1 for the formula.

A panel of three experienced tasters, tasted neat erythritol, as a control, and the composition from Example 1. Each panelist is asked to select the composition that has less “brightness”. All three panelists report that the erythritol-stevia composition had significantly less “brightness” than the control. They also report a pleasant sweet taste and a lack of bitterness that is expected from the stevia extract and in one case a mild, but pleasant root beer note.

TABLE 3-1

Example 1

| | A | |
|---|---|---|
| | Erythritol | B |
| Sweetener/Ingredient | Steia 65 | Erythritol |
| Maltodextrin | | |
| FOS | | |
| Erythritol | 80.00 | 80.00 |
| Fructose | | |
| Molasas Solids | | |
| Agave Nector (hydrolysed) | | |
| Sucralose | | |
| Sucrose | | |
| Concentrated Stevia (99 reb) | | |
| Concentrated Stevia (90 reb) | | |
| Concentrated Stevia (80 reb) | | |
| Concentrated Stevia (65 reb) | 0.13 | |
| Stevia Extract (~24% reb) | 0 | |
| Batch | 80.1300 | 80.0000 |
| g stevia/batch | 0.1300 | 0.0000 |
| mg stevia/tsp SES | 5.8 | 0.0 |
| g SES/batch | 89.94 | 56.00 |
| tsp SES/batch | 22.48 | 14.00 |
| grams SES/Gram | 1.12 | 0.70 |
| grams/tsp SES | 3.564 | 5.714 |
| cal/batch | 0.00 | 0.00 |
| cal tsp SES | 0.00 | 0.00 |
| % of sweetness from stevia | 37.7% | 0.0% |
| wt % stevia | 0.16% | 0.00% |
| wt % erythritol:wt % stevia | 615 | n/a |

### Example 2

The following three compositions are made by the method described in Example 1.

| | |
|---|---|
| Sample A | 100 grams of erythritol and 0.25 grams of stevia extract |
| Sample B | 100 grams of erythritol and 0.175 grams of stevia extract |
| Sample C | 100 grams of erythritol and 0..05 grams of stevia extract |

The erythritol is Exidex™ powder from Cargill, Inc, Minneapolis, Minn. The stevia extract is from the Idyll Life Co., Ltd., Bangkok, Thailand, and has a Rebaudioside A concentration of 99 wt % relative to all steviol glycosides.

Samples are dry blended and tasted by four experienced panelists. Each panelist place a 0.5 gram sample on the tip of their tongue and asked to rate the sample from most “cooling” to least “cooling”. The following results were obtained.

| Panelist | Most Cooling | | Least Cooling |
|---|---|---|---|
| 1 | A, C (equal) | | B |
| 2 | C | A | B |
| 3 | C | A | B |

| | |
|---|---|
| 4 | [panelist found samples A and B too bitter to judge] |

TABLE 3-2

| | Example 2 | | |
|---|---|---|---|
| | A | B | C |
| | Erythritol | Erythritol | Erythritol |
| Sweetener/Ingredient | Stevia 99 | Stevia 99 | Stevia 99 |
| Maltodextrin | | | |
| FOS | | | |
| Erythritol | 100.00 | 100.00 | 100.00 |
| Fructose | | | |
| Molasas Solids | | | |
| Agave Nector (hydrolysed) | | | |
| Sucralose | | | |
| Sucrose | | | |
| Concentrated Stevia (99 reb) | 0.25 | 0.18 | 0.0500 |
| Concentrated Stevia (90 reb) | | | |
| Concentrated Stevia (80 reb) | | | |
| Concentrated Stevia (65 reb) | | | |
| Stevia Extract (~24% reb) | | | |
| Batch | 100.2500 | 100.1750 | 100.0500 |
| g stevia/batch | 0.2500 | 0.1750 | 0.0500 |
| mg stevia/tsp SES | 6.6 | 5.5 | 2.3 |
| g SES/batch | 152.45 | 127.72 | 86.49 |
| tsp SES/batch | 38.11 | 31.93 | 21.62 |
| grams SES/Gram | 1.52 | 1.27 | 0.86 |
| grams/tsp SES | 2.630 | 3.137 | 4.627 |
| cal/batch | 0.00 | 0.00 | 0.00 |
| cal tsp SES | 0.00 | 0.00 | 0.00 |
| % of sweetess from Stevia | 54.1% | 45.2% | 19.1% |
| wt % stevia | 0.25% | 0.17% | 0.05% |
| wt % erythritol:wt % stevia | 400 | 571 | 2000 |

### Example 3

The following two compositions are made by the method described in Example 1.

| | |
|---|---|
| Sample A | 10 grams of Erythritol and 0.050 grams of Stevia Extract |
| Sample B | 10 grams of Erythritol and 0.025 grams of Stevia Extract |

The erythritol is Exidex™ powder from Cargill, Inc, Minneapolis, Minn. The Stevia extract was from the Idyll Life Co., Ltd., Bangkok, Thailand, and has a Rebaudioside A concentration of 99 wt % relative to all steviol glycosides.

Samples are dry blended and are tasted by an experienced panelest by placing a 0.5 gram sample on the tip of the panelist's tongue and asked to rate the sample from most “cooling” to least “cooling”. The following results are obtained.

Sample B is judged to be less cooling than sample A.

TABLE 3-3

Example 3

| | A | B |
|---|---|---|
| | Erythritol | Erythritol |
| Sweetener/Ingredient | Stevia 99 | Stevia 99 |
| Maltodextrin | | |
| FOS | | |
| Erythritol | 10.00 | 10.00 |
| Fructose | | |
| Molasas Solids | | |
| Agave Nector (hydrolysed) | | |
| Sucralose | | |
| Sucrose | | |
| Concentrated Stevia (99 reb) | 0.050 | 0.025 |
| Concentrated Stevia (90 reb) | | |
| Concentrated Stevia (80 reb) | | |
| Concentrated Stevia (65 reb) | | |
| Stevia Extract (~24% reb) | | |
| Batch | 10.0500 | 10.0250 |
| g stevia/batch | 0.0500 | 0.0250 |
| mg stevia/tsp SES | 8.5 | 6.6 |
| g SES/batch | 23.49 | 15.25 |
| tsp SES/batch | 5.87 | 3.81 |
| grams SES/Gram | 2.34 | 1.52 |
| grams/tsp SES | 1.711 | 2.630 |
| cal/batch | 0.00 | 0.00 |
| cal tsp SES | 0.00 | 0.00 |
| % of sweetess from Stevia | 70.2% | 54.1% |
| wt % stevia | 0.50% | 0.25% |
| wt % erythritol:wt % stevia | 200 | 400 |

The scope of the present invention is not limited by the description, examples, and suggested uses herein and modifications can be made without departing from the spirit of the invention. Thus, it is intended that the present invention cover modifications and variations of this invention provided that they come within the scope of the appended claims and their equivalents. Unless otherwise defined, all technical and scientific terms used herein have the same meaning as commonly understood by one of ordinary skill in the art to which this invention pertains. All publications, patent applications, patents, and other references mentioned herein are incorporated by reference in their entirety. In case of conflict, the present specification, including definitions, will control.

What is claimed is:

1. A sweetening composition comprising erythritol and a stevia extract, wherein from about 20% to about 75% of the sweetness of the composition comes from stevia and the stevia has a Rebaudioside A level of from about 80 wt % to about 99 wt % relative to all steviol glycosides.

2. The sweetening composition of claim 1, further comprising another sweet ingredient selected from the group consisting of a fructooligosaccharide, trehelose, a sugar alcohol, tagatose, a nutritive sugar, a high intensity sweetener, and mixtures thereof.

3. The sweetening composition of claim 1 having from about 1 to about 12 kcals per teaspoon of SES.

4. The sweetening composition of claim 1, further comprising a member from the group consisting of a flavor, an aroma, a nutritional ingredient and combinations thereof.

5. The sweetener composition of claim 1, further comprising a binder selected from the group consisting of microcrystalline cellulose, gum tragacanth, gelatin, leucine, lactose, and combinations thereof.

6. The sweetener composition of claim 5, wherein the binder is present in an amount of from about 10% to about 15%, by weight of the sweetener composition.

7. A sweetening composition comprising erythritol and stevia in a weight ratio of between about 200:about 1 to about 2000:about 1.

8. The sweetening composition of claim 7, wherein the weight ratio of erythritol to stevia is from about 400:about 1 to about 700:about 1.

9. A sweetening composition comprising erythritol and stevia, wherein the stevia has a Rebaudioside A level of from about 80 wt % to about 99 wt % relative to all steviol glycosides.

10. A sweetening composition comprising erythritol and stevia, wherein the stevia is present in an amount of from about 0.05 wt % to about 0.5 wt % of the composition and has a Rebaudioside A level of from about 80 wt % to about 99 wt % relative to all steviol glycosides.
